(19) United States
(12) Patent Application Publication
(10) Pub. No.: US 2025/0383455 A1
(43) Pub. Date: Dec. 18, 2025

(54) INFORMATION PROCESSING DEVICE, COMPUTER PROGRAM PRODUCT, AND INFORMATION PROCESSING METHOD

(71) Applicant: KABUSHIKI KAISHA TOSHIBA, Tokyo (JP)

(72) Inventor: Atsushi KAWASAKI, Yokohama (JP)

(73) Assignee: KABUSHIKI KAISHA TOSHIBA, Tokyo (JP)

(21) Appl. No.: 19/049,147

(22) Filed: Feb. 10, 2025

(30) Foreign Application Priority Data
Jun. 18, 2024 (JP) 2024-097911

(51) Int. Cl. G01S 19/40; G01S 19/48; G06V 20/56

(52) U.S. Cl. CPC G01S 19/40; G01S 19/485; G06V 20/588

(57) ABSTRACT

According to one embodiment, an information processing device includes a hardware processor. The processor calculates an error variation indicating a variation in error between a first absolute position of a mobile object and a relative position of the mobile object. The first absolute position is based on a global positioning system (GPS). The relative position is based on information other than the GPS. The processor calculates at least one section on a map in which the error variation is equal to or less than a first threshold value. The processor calculates a second absolute position on the map such that a constant difference loss becomes smaller. The constant difference loss is used for causing a difference between the first absolute position and the second absolute position to be constant for each of the sections.

### CROSS-REFERENCE TO RELATED APPLICATIONS

This application is based upon and claims the benefit of priority from Japanese Patent Application No. 2024-097911, filed on Jun. 18, 2024; the entire contents of which are incorporated herein by reference.

### FIELD

Embodiments described herein relate generally to an information processing device, a computer program product, and an information processing method.

### BACKGROUND

To visualize maintenance and inspection of infrastructure such as road defects, human flow, and movement of objects, technologies have been developed with which to collect driving data by means of a mobile object provided with a camera or a sensing device, such as light detection and ranging (LiDAR), and correctly estimate the position of the above target on a map from the driving data. Using a camera or a sensing device such as LiDAR on a mobile object, the relative position from the mobile object to a subject can be calculated, but the absolute position (such as latitude and longitude) of the subject on a map cannot be determined. To determine the absolute position of the subject, the absolute position of the mobile object needs to be determined first.

However, with conventional technologies, it has been difficult to calculate the absolute position of the mobile object on the map more accurately.

### BRIEF DESCRIPTION OF THE DRAWINGS

FIG. 1 is a diagram illustrating an example of a functional configuration of an information processing device according to an embodiment;

FIG. 2 is a diagram illustrating an overview of route matching;

FIG. 3 is a diagram for describing an example (when landmarks are used) of processing of a correction position acquisition unit 102 according to the embodiment;

FIG. 4A is a diagram for describing an example (when lane numbers are used) of processing of the correction position acquisition unit 102 according to the embodiment;

FIG. 4B is a diagram illustrating an example of a camera image according to the embodiment;

FIG. 5 is a diagram for describing an example of processing of a section calculation unit according to the embodiment;

FIG. 6 is a diagram illustrating an example of a functional configuration of a second absolute position calculation unit according to the embodiment;

FIG. 7 is a diagram for describing an error constant loss according to the embodiment;

FIG. 8 is a flowchart illustrating an example of an information processing method according to the embodiment; and

FIG. 9 is a diagram illustrating an example of a hardware configuration of the information processing device according to the embodiment.

### DETAILED DESCRIPTION

An information processing device according to an embodiment includes a hardware processor connected to a memory. The hardware processor is configured to calculate an error variation indicating a variation in error between a first absolute position of a mobile object and a relative position of the mobile object. The first absolute position is based on a global positioning system (GPS). The relative position is based on information other than the GPS. The hardware processor is configured to calculate at least one section on a map in which the error variation is equal to or less than a first threshold value. The hardware processor is configured to calculate a second absolute position on the map such that a constant difference loss becomes smaller. The constant difference loss is used for causing a difference between the first absolute position and the second absolute position to be constant for each of the sections.

Exemplary embodiments of an information processing device, a computer program product, and an information processing method will be described below in detail with reference to the accompanying drawings.

As a general method, the absolute position of a mobile object such as a motor vehicle can be acquired by using GPS. However, a low-cost GPS installed in a drive recorder or the like has low positional accuracy due to its stand-alone positioning, resulting in errors of about 1 m to 10 m. There is also a technique called route matching (used in car navigation systems) that utilizes the GPS and road information to correct GPS values to the nearest road, but the road information widely used includes road centerlines alone and does not allow highly accurate self-position estimation.

Conventional self-estimation needs acquisition of a correction position every time when the environment or the behavior of a subject vehicle changes. In particular, changes in the behavior of the subject vehicle and conditions such as changes in the number of GPS positioning satellites cannot be controlled, thus a large number of landmarks inevitably need to be placed. However, setting a large number of such landmark information over a wide area is costly and impractical.

In the following embodiment, relative positions calculated from camera images taken by an in-vehicle camera or the like, road information such as road centerlines, and GPS values are combined in offline processing. This enables position estimation on a map at the lane level from a smaller number of GPS correction positions acquired independent of changes in the environment or the subject vehicle.

### Example of Functional Configuration

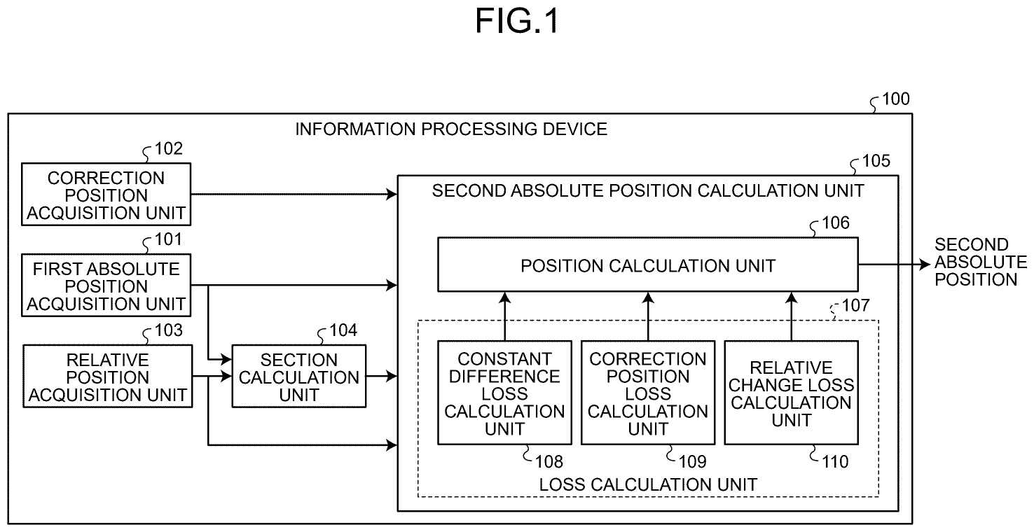

FIG. 1 is a diagram illustrating an example of a functional configuration of an information processing device 100 according to an embodiment. The information processing device 100 of the embodiment is provided in a mobile object such as a motor vehicle, for example. The information processing device 100 of the embodiment includes a first absolute position acquisition unit 101, a correction position acquisition unit 102, a relative position acquisition unit 103, a section calculation unit 104, and a second absolute position calculation unit 105.

The first absolute position acquisition unit 101 acquires a first absolute position of the mobile object that indicates its self-position on a map, on the basis of the GPS. The GPS-based self-position on the map may be the GPS value as is, or may be an absolute position obtained by correcting the GPS value by using road information that includes at least one of the number of lanes, a lane centerline, or the road width. An example of correction using road information includes, for example, route matching used in car navigation systems.

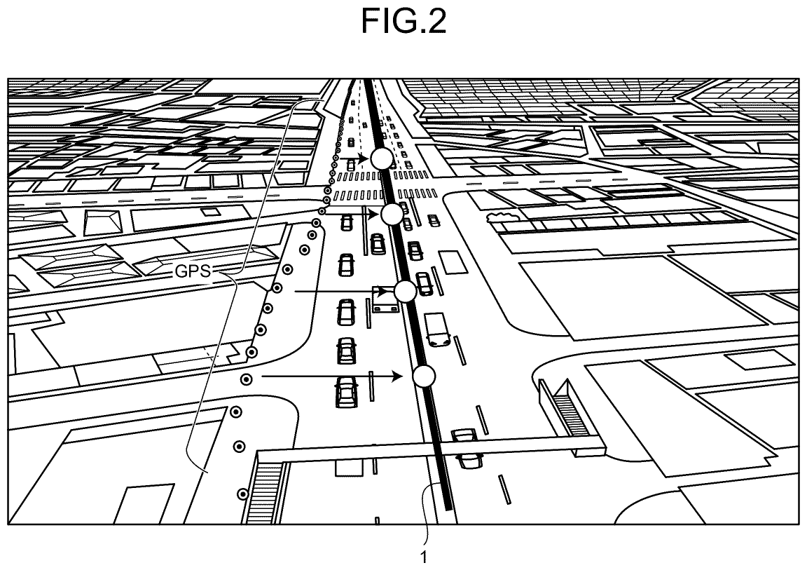

FIG. 2 is a diagram illustrating an overview of route matching. Route matching is a technique using a time-series GPS to correct the position by shifting it to the nearest road. In general route matching, the position is pulled over to a road centerline 1. Thus, it cannot estimate the position at the lane level, such as which lane the vehicle is traveling in. Also, even if the subject vehicle changes lanes, the correction position after route matching remains straight on the road centerline 1.

The absolute position corrected by such route matching or other techniques may be acquired by the first absolute position acquisition unit 101. The information processing device 100 of the embodiment uses an error self-position (first absolute position) as input and finally outputs a self-position (second absolute position) that is more accurate than the first absolute position.

The description returns to FIG. 1. The correction position acquisition unit 102 acquires the correction position of the first absolute position by correcting the first absolute position at one or more time points.

The details of a method by which the correction position acquisition unit 102 acquires a correction position will be described next. In the present embodiment, at least one correction position is sufficient. Because a correction position is an absolute position on a map that is also acquired by means other than the GPS, various acquisition methods are possible. Four examples of acquisition methods will be introduced below.

### (1) Case of Using Landmarks

The first example of the method for acquiring a correction position is to use the absolute positions of landmarks registered on the map and camera images to acquire a correction position of the first absolute position by mapping the landmarks on the camera image to those on the map. Objects that have a higher frequency of occurrence in the environment from which the position is estimated are often used as landmarks. Landmarks can be traffic signals, signs, pedestrian crossings, white lines, stop lines, and buildings.

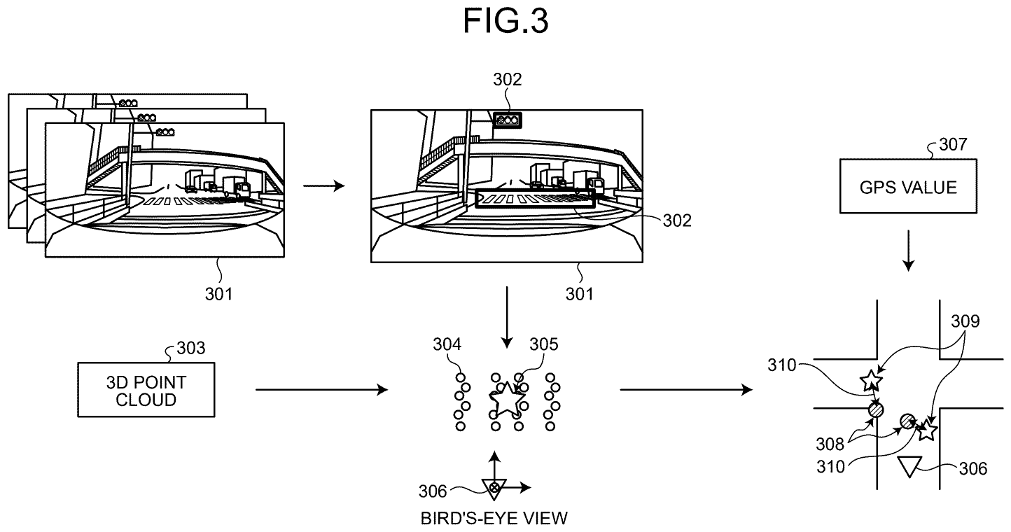

FIG. 3 is a diagram for describing an example (when landmarks are used) of processing of the correction position acquisition unit 102 according to the embodiment. The correction position acquisition unit 102 uses camera images 301, a three-dimensional (3D) point cloud 303, a GPS value 307, and absolute positions of landmarks 308 registered in advance on the map in the processing of acquiring a correction position.

In one example, the 3D point cloud 303 is a point cloud acquired by a laser sensor such as LiDAR. In one example, the 3D point cloud 303 may be a 3D point cloud of the surrounding environment calculated from camera images by visual simultaneous localization and mapping (SLAM) or other methods. In one example, the 3D point cloud 303 is a 3D point cloud obtained from a camera 306 when the camera 306 is a stereo camera.

The position of the 3D point cloud 303 is represented on a coordinate system with the origin at the position of the camera 306 (or LiDAR sensor) at a time point included in the GPS value 307.

First, the correction position acquisition unit 102 detects and tracks positions of landmarks on the camera image 301 by using a detector that detects (recognizes) objects on the camera image 301 and identifies areas of landmarks 302 on the image.

Next, the correction position acquisition unit 102 extracts a 3D point cloud 304 included within the detection area on the camera image 301 by using the area of the landmark 302 on the camera image 301 and the 3D point cloud 303. Then, the correction position acquisition unit 102 determines a representative point 305 of the 3D point cloud 304. The representative point may be the average value of the 3D point cloud 304 or the median value determined for each coordinate axis.

Next, the correction position acquisition unit 102 converts the 3D position (representative point 305) of the landmark to an initial position 309 of the absolute position on the map by using the GPS value 307 at a given time point. The representative point 305 is a position relative to the camera 306 (or LiDAR sensor) because it is a value on a coordinate system with the origin at the position of the camera 306 (or LiDAR sensor) at a time point indicated by the GPS value 307. The correction position acquisition unit 102 determines the initial position 309 on the map of the landmark 302 from the relative position obtained from the camera image 301 and the absolute position indicated by the GPS value 307. The correction position acquisition unit 102 maps landmarks of the same type that are closest in distance to each other on the basis of the initial position 309 of the landmark 302 and the absolute position of the landmark 308 registered in advance. This operation results in mapping 310 between the landmark 308 on the map and the landmark 302 on the camera image 301.

Next, the correction position acquisition unit 102 determines a correction position of the first absolute position (GPS value 307) from this mapping 310. Specifically, when the number of mapping is small, such as one, the correction position acquisition unit 102 moves the first absolute position alone while maintaining the relative positional relation between the first absolute position (GPS value 307) and the initial position 309 of the landmark 302 determined from the camera image 301 and the GPS value 307. Then, the correction position acquisition unit 102 sets the position at which the position error between the landmark 308 registered in advance and the initial position 309 of the landmark 302 is the smallest as a final correction position of the first absolute position. In one example, when the number of mapping is just one, the difference vector between the initial position 309 of the landmark 302 and the position of the landmark 308 registered in advance, added to the first absolute position (GPS value 307), is the correction position.

When the number of mapping is more than one, the correction position acquisition unit 102 moves at least one of the first absolute position or the orientation at the first absolute position while maintaining the relative positional relation between the initial position 309 of the landmark 302 and the first absolute position (GPS value 307). Then, the correction position acquisition unit 102 determines the position and the orientation with the smallest position error between the landmark 308 registered in advance and the initial position 309 of the landmark 302 by using the ICP algorithm or other methods. The position thus obtained is the final correction position of the first absolute position.

### (2) Case of Using Lane Numbers

The second example of the method for acquiring a correction position is to use map information in which road information is registered and a lane number in which the subject vehicle is traveling, which is acquired from the camera image, to calculate a correction position. The map information is to include at least one or more of the number of lanes, a lane centerline, and the road width.

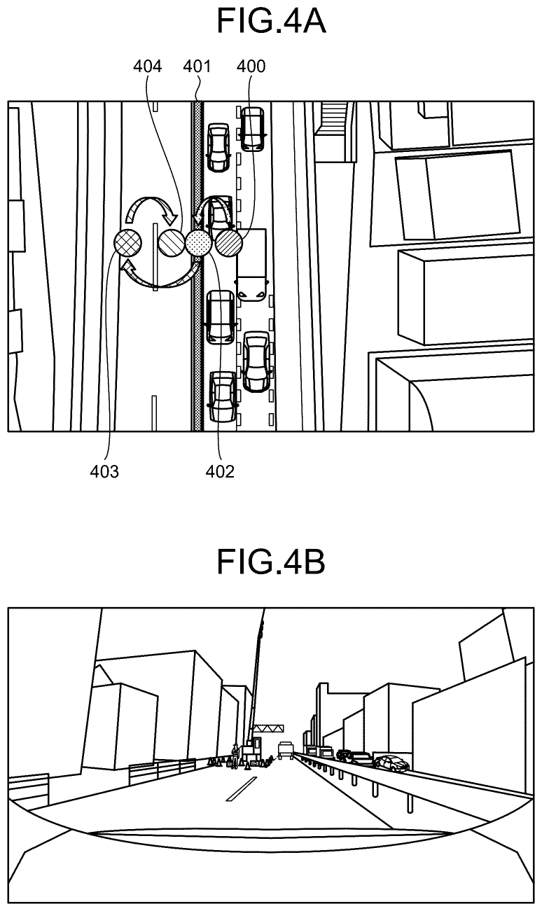

FIG. 4A is a diagram for describing an example (when lane numbers are used) of processing of the correction position acquisition unit 102 according to the embodiment. The second method for acquiring a correction position includes the following four steps.

First, the correction position acquisition unit 102 corrects a first absolute position 400 based on the GPS value to an absolute position 402 on a road centerline 401 by route matching.

Next, the correction position acquisition unit 102 determines the absolute position 402 of the left end of the lane (left end of the travel lane). Specifically, the correction position acquisition unit 102 determines, from the number of lanes included in the map and the road width, the distance from the road centerline to the left end of the lane. Then, the correction position acquisition unit 102 calculates a point on a straight line perpendicular to the road centerline 401, the point passing through the absolute position 402 on the road centerline 401, the point being the distance from the absolute position 402 to the left end of the lane, as the absolute position 402 of the left end of the lane.

For the road width, a value included in the map information may be used, or a generally defined road width value may be used.

Next, the correction position acquisition unit 102 identifies which lane from the left the vehicle is traveling in, from the camera image at the time point when the first absolute position 400 based on the GPS value was acquired. Then, the correction position acquisition unit 102 acquires a lane number indicating the identified lane.

FIG. 4B is a diagram illustrating an example of a camera image according to the embodiment. In the example camera image in FIG. 4B, the correction position acquisition unit 102 acquires lane number 2 indicating the “second” lane. In one example, the correction position acquisition unit 102 may receive an operational input indicating the lane number from a user via an input device. In one example, the correction position acquisition unit 102 may use image processing with lane detection to acquire the lane number from the camera image. In one example, the correction position acquisition unit 102 may use a deep neural network that answers questions about the camera image to acquire the lane number from the camera image.

The description returns to FIG. 4A. The correction position acquisition unit 102 determines a final correction position 404 of the first absolute position 400 from the lane width and lane number. Specifically, the correction position acquisition unit 102 determines the distance from an absolute position 403 of the left end of the lane to the correction position 404 by the lane width×the lane number. Then, the correction position acquisition unit 102 sets, as the correction position 404 of the first absolute position 400, a point on a straight line perpendicular to the road centerline 401, the point passing through the absolute position 403 of the left end of the lane, the point being the distance of the lane width x the lane number from the absolute position 403 of the left end of the lane. For the lane width, a value included in the map information may be used, or a generally defined road width value may be used.

The above method for acquiring a correction position is merely an example, and a position of the right end of the lane and a lane number from the right end may be used.

### (3) Case of Using an Image Corresponding to the Absolute Position on the Map

The third example of the method for acquiring a correction position is to calculate a correction position by mapping a camera image to an image corresponding to the absolute position on the map.

In the embodiment, the correction position acquisition unit 102 refers to a database that stores therein images and positions on the map of places indicated by the image. The database may be provided in the information processing device 100 or in a server device communicating with the information processing device 100. The images stored in the database may be camera images taken by an in-vehicle camera or the like in the past, or may be satellite images centered on positions on the map registered in the database.

First, the correction position acquisition unit 102 extracts images of registered points on the database that are included within a distance threshold from the first absolute position by using the first absolute position based on the GPS value and a preset distance threshold. Then, the correction position acquisition unit 102 selects, from the database, an image having the highest degree of similarity (similarity to the camera image is equal to or larger than a second threshold) to the camera image when the first absolute position was acquired, and calculates a position relative to the selected image. In one example, this series of processing may be implemented by using a deep neural network. In one example, the processing of selecting an image having a high degree of similarity may be implemented by using a deep neural network, and the processing of calculating a position relative to the selected image may be implemented by using geometric operations with feature point matching.

The correction position acquisition unit 102 calculates a correction position of the first absolute position by adding the relative position of the first absolute position and the absolute position of the selected image to the absolute position of the selected image registered in the database.

### (4) Other Methods for Acquiring a Correction Position

As another example of the method for acquiring a correction position, a position acquired from a beacon placed on the road may be used as a correction position of the first absolute position based on the GPS value. Specifically, the correction position acquisition unit 102 acquires a correction position of the first absolute position through roadside-to-vehicle communication between a beacon transmitter (access point device) located in the environment and a beacon receiver installed in the vehicle. The roadside-to-vehicle communication is, for example, wireless local area network (LAN) communication or Bluetooth communication.

As still another example of the method for acquiring a correction position, an operational input indicating the correction position of the first absolute position may be received from the user via an input device. Specifically, an operational input indicating the correction position of the first absolute position may be received by the user, with the camera image when the first absolute position was acquired and common sense, such as traveling over the center of the lane, as cues.

While various methods (1) through (4) for acquiring a correction position of the first absolute position have been described, correction positions used for calculating the second absolute position are not limited to those acquired by one method. In other words, at least one correction position obtained by the methods (1) through (4) for acquiring a correction position described above may be used.

The description returns to FIG. 1. The relative position acquisition unit 103 acquires at least one of the time-series relative position or orientation from information other than the GPS. The relative position and the orientation are acquired from the amount of change indicating the position and the orientation of the subject vehicle in adjacent frames of the camera image, for example.

Information obtained from camera images, wheel speed, gyro sensors, or devices such as LiDAR sensors is used as the information other than the GPS. For example, from a camera image or LiDAR, the relative position and the orientation of the subject vehicle can be determined by SLAM technology.

The section calculation unit 104 calculates a section with the smallest error variation that indicates the error variation between the first absolute position and the relative position. Two calculation methods will be described as examples of methods for calculating a section with a small error variation.

### (1) Method by Comparison of Trajectories

The first method for calculating a section with a small error variation is to compare a trajectory of the relative position with a trajectory of the first absolute position and calculate, as a section with a small error variation, a section in which time points when a position error or orientation error of the two trajectories is equal to or less than a threshold value are consecutive.

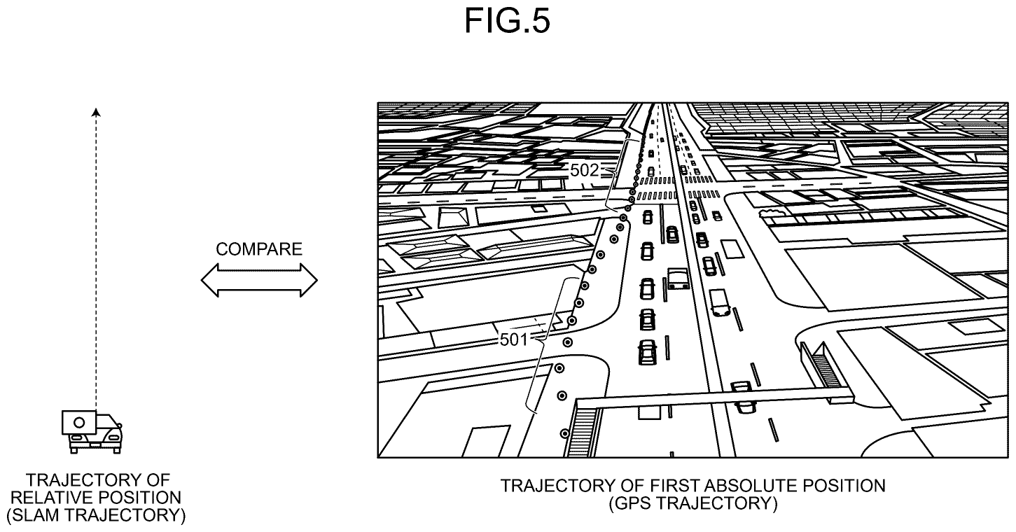

FIG. 5 is a diagram for describing an example of processing of the section calculation unit 104 according to the embodiment. The section calculation unit 104 calculates a section in which time points when an error between the trajectory of the relative position and the trajectory of the first absolute position is equal to or less than a threshold value.

The trajectory of the relative position refers to a trajectory obtained by superimposing the time-series relative positions in the direction of time points. The trajectory of the first absolute position refers to a set of first absolute positions at a plurality of time points. Both the first absolute position and relative position may be used in the trajectory comparison processing, or either one may be used.

When comparing two trajectories, the section calculation unit 104 divides the trajectory by a predetermined travel distance or time interval.

Next, the section calculation unit 104 aligns the divided trajectories with each other. In alignment, the section calculation unit 104 calculates transformation (rotation, translation, or scale) that minimizes the distance between trajectories at the same time point while maintaining the shape of the trajectory. The calculated transformation is performed on one trajectory, allowing the two trajectories to be compared in the same coordinate system. The section calculation unit 104 compares the transformed trajectories and calculates, as a section with a small error variation, a section in which time points when a position error or orientation error is equal to or less than a predetermined first threshold value are consecutive.

The section calculation unit 104 performs the above processing for the number of sections of the divided trajectory. In the example in FIG. 5, sections 501 and 502 of the divided trajectory are calculated as sections with a small error variation. As illustrated in FIG. 5, a section with a high degree of agreement between the position of the SLAM trajectory and the position of the GPS trajectory is calculated as the section with a small error variation.

### (2) Method Using Changes in Relative Position, GPS Accuracy, etc.

The second method for calculating a section with a small error variation is to calculate, as a section with a small error variation (section on the map in which the error variation is equal to or less than the first threshold value), a section in which the amount of change in at least one of the speed or the orientation of the mobile object is equal to or less than a third threshold value, a section in which the accuracy of the GPS is equal to or larger than a fourth threshold value, or a section in which the change in the number of positioning satellites is equal to or less than a fifth threshold value.

The GPS has the property of a GPS error not varying significantly (property of a GPS error being equal to or less than a threshold value) when the structure environment is constant, a change in the behavior of the subject vehicle (e.g., speed changes or left and right turns) is equal to or less than a threshold value, and the combination of satellites used for positioning remains the same. By using this property, a section with a high degree of agreement is determined. Specifically, the section calculation unit 104 calculates the amount of change in at least one of the speed or the orientation of the mobile object from the relative positions calculated at the plural time points, and calculates, as a section with a small error variation, a section in which the amount of change is equal to or less than the predetermined third threshold value.

The accuracy can be acquired from the GPS. Therefore, a section in which the accuracy is equal to or larger than the predetermined fourth threshold value may be calculated as a section with a small error variation.

The number of positioning satellites can be acquired from the GPS. Therefore, a section in which the combination or number of satellites used for positioning remains the same may be calculated as a section with a small error variation.

The two methods for calculating a section with a small error variation have been introduced above, and one or more sections obtained by the above calculation methods are used. In addition, AND or OR of sections acquired by plural calculation methods may be taken.

The description returns to FIG. 1. The second absolute position calculation unit 105 includes a position calculation unit 106 and a loss calculation unit 107. The loss calculation unit 107 includes a constant difference loss calculation unit 108, a correction position loss calculation unit 109, and a relative change loss calculation unit 110.

The second absolute position calculation unit 105 calculates a second absolute position including at least one of the self-position or the orientation on the map at the time point of acquiring the correction position and at time points other than the time point of acquisition, by using the first absolute position described above, the relative position described above, the correction position at one or more time points described above, and the section with a small error variation described above.

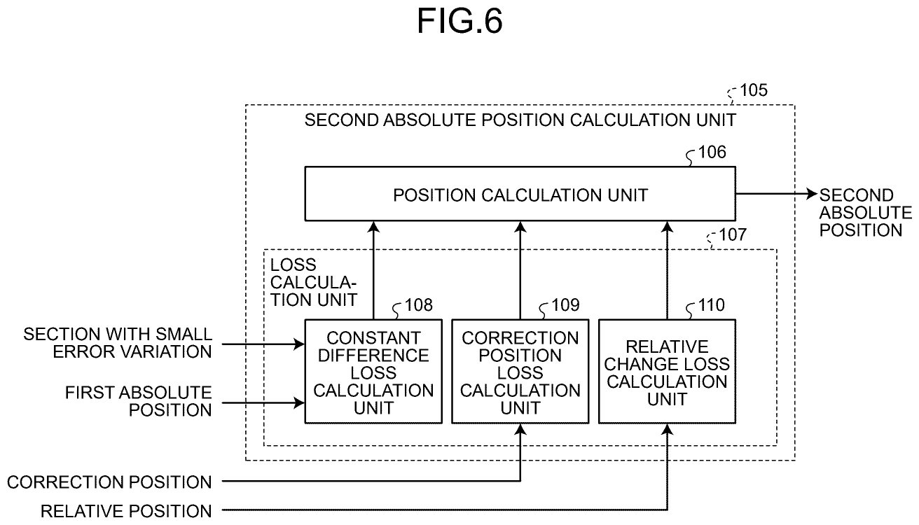

FIG. 6 is a diagram illustrating an example of a functional configuration of the second absolute position calculation unit 105 according to the embodiment. The second absolute position calculation unit 105 of the embodiment includes a position calculation unit 106 and a loss calculation unit 107.

The loss calculation unit 107 calculates a loss to be used for calculating the absolute position based on the first absolute position described above, the relative position described above, the correction position at one or more time points described above, and the section with a small error variation described above (section with a high degree of agreement between the position of the SLAM trajectory and the position of the GPS trajectory). Then, the position calculation unit 106 calculates the second absolute position at which the loss approaches a minimum.

Specifically, the loss calculation unit 107 includes the constant difference loss calculation unit 108, the correction position loss calculation unit 109, and the relative change loss calculation unit 110.

The constant difference loss calculation unit 108 calculates a loss to be used in processing of bringing the difference between the second absolute position and the first absolute position closer to being constant for each section with a small error variation described above.

The correction position loss calculation unit 109 calculates a loss to be used in processing of bringing the second absolute position at the time point when the correction position was acquired described above closer to the correction position described above.

The relative change loss calculation unit 110 calculates a loss to be used in processing of bringing a time-series change in the second absolute position closer to the time-series change in the relative position described above.

At least one of the constant difference loss calculation unit 108, the correction position loss calculation unit 109, or the relative change loss calculation unit 110 may be provided.

Losses will be described in detail below.

### (1) Constant Difference Loss

The constant difference loss calculation unit 108 uses the first absolute position described above and the section with a small error variation described above as inputs to calculate a constant difference loss used for position calculation that causes the difference between the first absolute position and the second absolute position to be estimated to be constant for each of the sections.

The constant difference loss is a loss that makes a discrepancy between the GPS trajectory and the estimated trajectory stationary by using the property of a GPS error being stationary (constant) when the structure environment is constant, a change in the behavior of the subject vehicle is small (equal to or less than a threshold value), and the combination of satellites used for positioning remains the same.

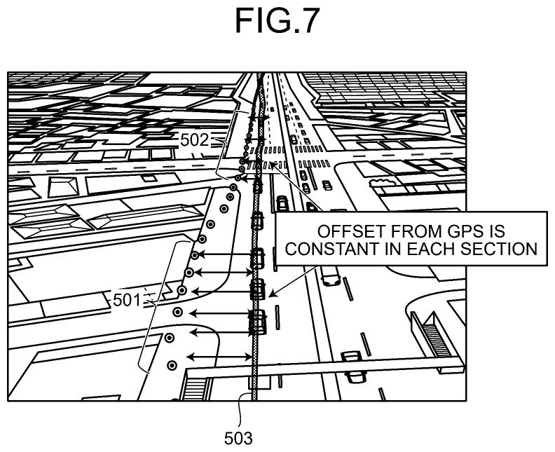

FIG. 7 is a diagram for describing the error constant loss according to the embodiment. Conventionally, trajectories have been connected between absolute positions given by the correction positions described above by optimization through the relative change loss. However, because of drift errors in the relative trajectory due to time-series accumulation, the trajectory at the time of a curve could be small or large, and the estimated absolute position error could also be large. Adding this error constant loss allows an estimated trajectory 503 (estimated trajectory of the second absolute position) from the GPS trajectory to be stationary, and the effect of suppressing the small or large turn of the trajectory at the time of a curve can be expected.

Information after the point at which the GPS error property changes cannot be used in real-time processing, but the embodiment assumes that this is performed in offline processing, and the information after the point at which the GPS error property changes can also be used. Thus, providing this error constant loss to a plurality of sections with a small error variation (in the example in FIG. 7, the sections 501 and 502 in which the SLAM and GPS trajectories have a high degree of agreement) makes it unnecessary to acquire a correction position at the timing at which the error property changes, needing just a small number (at least one) of GPS correction positions.

This error constant loss is not used for all frames and GPS trajectories, but for sections with a small error variation described above alone. When the stationarity of GPS errors breaks down due to an environmental change or when GPS values are unstable, the constant difference loss has a negative impact and is thus used for the limited section with a small error variation described above alone.

Specifically, a constant difference loss E_{bias} is defined by equation (1) below by using a residual e_{bias} and a variance Σ_{bias}.

$${E}_{bias} = {\sum }_{s = 1}^{S} {( {e}_{bias}^{s} )}^{T} {\sum }_{bias} ( {e}_{bias}^{s} ) \qquad ( 1 )$$

Here, S is the number of sections with a small error variation described above. The residual e_{bias} is designed such that the error variance between the position component (coordinates tₓ and t_{z} in the x-z plane (ground)) of the estimated second absolute position and the GPS value is small in the section with a small error variation described above. First, the constant difference loss calculation unit 108 calculates a straight line (aₛx+bₛy+cₛ=0) in the x-z plane (ground) that passes through the GPS value in the section s with a small error variation, by using least squares or other methods. aₛ, bₛ, and cₛ are fixed variables.

Then, the constant difference loss calculation unit 108 calculates the distance to the straight line for each of position components (t_{g, x}, t_{g, z}) of the second absolute positions corresponding to the time point g when the GPS value in section s was acquired, and defines a bias error as in equations (2) through (4) below.

$${e}_{bias} = [ {e}_{1} , ... , {e}_{g} , ... , {e}_{G} ] ∈ {ℝ}^{G} \qquad ( 2 )$$

$${e}_{g} = {d}_{g} - \frac{1}{G} {\sum }_{g = 1}^{G} {d}_{g} \qquad ( 3 )$$

$${d}_{g} = \frac{{a}_{s} {t}_{g , x} + {b}_{s} {t}_{g , z} + {c}_{s}}{\sqrt{{a}_{s}^{2} + {b}_{s}^{2}}} \qquad ( 4 )$$

Here, G is the number of GPS values within one section with a small error variation. The constant difference loss calculation unit 108 calculates one error e_{g} per GPS value. The error e_{g} is a difference between the distance (distance d_{g} between the point and the straight line) between the point indicated by the position component of the second absolute position and the straight line that passes through each GPS value (point in the x-z plane (ground)) and the average of G d_{g}.

Making this error e_{g} the loss of position estimation enables the error between the second absolute position and the GPS value to be constant (smaller variance) within the section.

### (2) Correction Position Loss

The correction position loss calculation unit 109 calculates a correction position loss to be used in the processing of bringing the second absolute position at the time point when the correction position was acquired described above closer to the relevant correction position. The error indicated by this correction position loss can be expected to have the effect of correcting the errors in GPS values. In the embodiment, with the introduction of the constant difference loss, the number of correction positions may be small (at least one), and correction positions may be acquired at any given timing independent of the environment.

Specifically, a correction position loss Σ_{anchor} is defined by using a residual eⁿ_{anchor} and a variance Σ_{anchor} at each correction position in the form below.

$${E}_{anchor} = {\sum }_{n = 1}^{N} {( {e}_{anchor}^{n} )}^{T} {\sum }_{anchor} ( {e}_{anchor}^{n} ) \qquad ( 5 )$$

Here, N is the number of correction positions acquired. The residual eⁿ_{anchor} is a difference between a correction position xₜ at the time point t and the position component tₜ=(tₓ, t_{y}, t_{z}) of the estimated second absolute position, and is defined by equation (6) below.

$${e}_{anchor}^{n} = {t}_{t} - {x}_{t} \qquad ( 6 )$$

There are various methods for acquiring a correction position, as described above. Each acquisition method may be stable and highly accurate, or may have characteristics such as being error-prone in the direction in which the subject vehicle is traveling, or error-prone in the left and right direction. The correction position loss calculation unit 109 may adjust, to meet the method of calculating the correction position, the weight of the correction position loss for the direction in which the mobile object is traveling or for the left and right direction of the mobile object.

For example, in the case (1) using the landmarks (e.g., stop lines and pedestrian crossings), errors in the left and right direction are likely to occur when being detected from images. Thus, in this case, errors in the left and right direction are likely to occur. In the case (2) using the lane numbers, correction is made in the left and right direction on the basis of the position obtained by route matching. Thus, in this case, errors in the traveling direction are likely to occur. Therefore, the correction position loss calculation unit 109 adjusts the weight (Σ_{anchor}) of the loss to the traveling direction or the left and right direction of the self-position on the basis of the methods for calculating a correction position described above. The adjustment method may be designed by the user, or the adjustment may be made during optimization in the position calculation unit 106.

### (3) Relative Change Loss

The relative change loss calculation unit 110 calculates a relative change loss to be used in the processing of bringing a time-series change in the second absolute position described above closer to the time-series change in the relative position described above. This relative change loss can be expected to have the effect of smoothly connecting between GPS correction position values that are accurate but a few points, by using at least one of the relative position or the orientation that are dense on a time-series basis estimated by a camera or LiDAR.

Specifically, a relative change loss Eᵣₑₗ is defined by equation (7) below by using a residual eᵣₑₗ and variance Σᵣₑₗ.

$${E}_{rel} = {\sum }_{t = 2}^{T} {( {e}_{rel}^{t} )}^{T} {\sum }_{rel} ( {e}_{rel}^{t} ) \qquad ( 7 )$$

To explain the residual eᵣₑₗ, the position component and orientation component of the estimated second absolute position are defined as Tₜ, and a change in the position component and a change in the orientation component between frames in the relative position described above are defined as ΔOₜ₋₁₋ₜ. Here, Tₜ and ΔOₜ₋₁₋ₜ are sources of the rigid body transformation SE(3) in 3D space.

The residual eᵣₑₗ is calculated by parameterizing the transformation representing each position and orientation from the rigid body transformation SE(3) to a similarity transformation Sim(3). The relative change loss calculation unit 110 transforms Tt of the second absolute position into a source Tₜ of the similarity transformation Sim(3) and AOₜ₋₁₋ₜ of the relative position into a source oₜ of the similarity transformation Sim(3).

Sim(3) is defined in seven dimensions (φₓ, φ_{y}, φ_{z}, tₓ, t_{y}, t_{z}, s) and can be transformed into matrix form as τ=(sR|t). In converting parameters from SE(3) to Sim(3), a scale is added to the estimated parameters. The residual is defined as in equation (8) below.

$${e}_{rel}^{t} = ξ ( {{τ}_{t - 1}}^{- 1} {τ}_{t} Δ {O}_{t - 1 \to t} ) - b \qquad ( 8 )$$

The relative change loss calculation unit 110 estimates the second absolute position τₜ₋₁, τₜ at which the residual eᵣₑₗ is minimized, by using the relative position ΔOₜ₋₁₋ₜ of an adjacent frame as a constraint (fixed) condition. Here, ζ(.) is the transformation from the matrix representation of the relative position and the orientation to the seven-dimensional parameters of the similarity transformation Sim (3). b is the bias for adjusting the scale parameter.

In the embodiment, the losses have been calculated by converting the absolute position and the orientation to a similarity transformation, but may be calculated as a rigid body transformation.

The position calculation unit 106 calculates a second absolute position by using the losses described above as inputs. Specifically, the position calculation unit 106 adds the losses together and calculates the second absolute position (at least one of the position or orientation components) at which the added loss is minimized. Algorithms such as the Levenberg-Marquardt or Gauss-Newton method for solving nonlinear least-squares problems are used for calculating the second absolute position.

The position calculation unit 106 may calculate the second absolute position by using some of the losses described above as inputs. In one example, the position calculation unit 106 may calculate the second absolute position such that the constant difference loss to bring the difference between the first absolute position and the second absolute position on the map closer to being constant for each section with a small error variation described above becomes smaller.

In one example, the position calculation unit 106 may calculate the second absolute position such that the correction position loss becomes smaller, further on the basis of the correction position loss to bring the second absolute position at one or more time points closer to the correction position of the first absolute position obtained at one or more time points.

In one example, the position calculation unit 106 may calculate the second absolute position including at least one of the position or the orientation of the mobile object such that the relative change loss becomes smaller, further on the basis of the relative change loss to bring the time-series change in the second absolute position closer to the time-series change in the relative position.

### Example of Information Processing Method

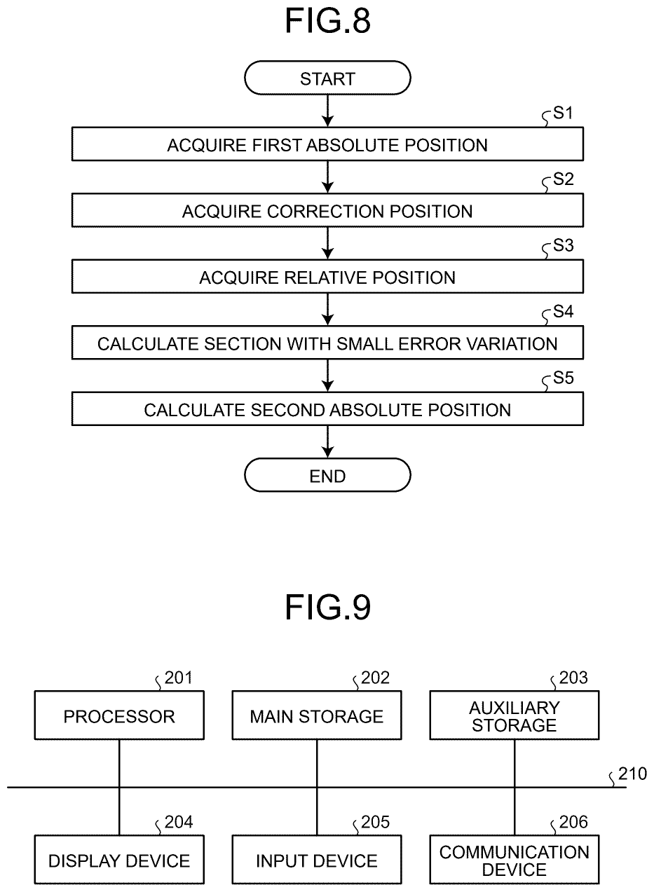

FIG. 8 is a flowchart illustrating an example of an information processing method according to the embodiment. First, the first absolute position acquisition unit 101 acquires a first absolute position of the mobile object that indicates its self-position on a map, on the basis of the GPS (step S1).

Next, the correction position acquisition unit 102 acquires a correction position of the first absolute position by correcting the first absolute position at one or more time points (step S2).

Next, the relative position acquisition unit 103 acquires a time-series relative position from information other than the GPS (step S3).

Next, the section calculation unit 104 calculates at least one section with a small error variation that indicates the error variation between the first absolute position and the relative position, by using the calculation methods described above (step S4).

Next, the second absolute position calculation unit 105 calculates a second absolute position such that, for example, the constant difference loss to bring the difference between the first absolute position and the second absolute position on the map closer to being constant for each section calculated at step S4 becomes smaller (step S5).

As described above, in the information processing device 100 of the embodiment, the section calculation unit 104 calculates an error variation between the position indicated by the first absolute position and the position indicated by the relative position from the first absolute position of the mobile object based on the GPS and the relative position of the mobile object based on information other than the GPS, and calculates at least one section on the map in which the error variation is equal to or less than the first threshold value. Then, the second absolute position calculation unit 105 calculates the second absolute position such that the constant difference loss to bring the difference between the first absolute position and the second absolute position on the map closer to being constant for each section becomes smaller.

This operation allows the information processing device 100 of the embodiment to calculate the absolute position of the mobile object on the map more accurately. Specifically, because the information processing device 100 of the embodiment performs offline processing, unlike online real-time processing, information at or after a change point of the GPS error property can also be used. Thus, providing the constant difference loss to a plurality of sections with a small error variation makes it unnecessary to acquire a correction position at the timing at which the error property changes, needing just a small number (at least one) of GPS correction positions. Correction positions may be acquired at any given timing independent of the environment.

In the case of using landmarks for acquiring correction positions, the number of landmarks places can be reduced. When correction position input is received from the user, the user's effort can be reduced because only a smaller number of correction positions need to be input than ever.

In the case of using camera images, wheel speed, and/or LiDAR for calculating the relative position, drift errors in the relative position due to time-series accumulation can also be reduced.

Finally, an example of a hardware configuration of the information processing device 100 of the embodiment will be described.

### Example of Hardware Configuration

FIG. 9 is a diagram illustrating the example of the hardware configuration of the information processing device 100 according to the embodiment. The information processing device 100 of the embodiment includes a processor 201, main storage 202, auxiliary storage 203, a display device 204, an input device 205, and a communication device 206. The processor 201, the main storage 202, the auxiliary storage 203, the display device 204, the input device 205, and the communication device 206 are connected via a bus 210.

The information processing device 100 does not have to include some of the above constituents. In one example, when the information processing device 100 can use input and display functions of an external device, the information processing device 100 does not have to include the display device 204 and the input device 205.

The processor 201 executes a computer program read from the auxiliary storage 203 to the main storage 202. The main storage 202 is memory such as read-only memory (ROM) and random-access memory (RAM). The auxiliary storage 203 is a hard disk drive (HDD), a memory card, and the like.

The display device 204 is, for example, a liquid crystal display. The input device 205 is an interface for operating the information processing device 100. The display device 204 and the input device 205 may be implemented by a touch panel or the like having both display and input functions. The communication device 206 is an interface for communicating with other devices.

A computer program to be executed by the information processing device 100 may be provided as a computer program product in which an installable or executable file is recorded on a computer-readable storage medium, such as a memory card, hard disk, CD-RW, CD-ROM, CD-R, DVD-RAM, and DVD-R.

The computer program to be executed by the information processing device 100 may be stored on a computer connected to a network, such as the Internet, and may be configured to be provided by having the computer program downloaded over the network.

The computer program to be executed by the information processing device 100 may be configured to be provided over a network, such as the Internet, without being downloaded. Specifically, a server computer may be configured to execute information processing through a service provided by what is called an application service provider (ASP), the service not transferring the computer program but implementing processing functions through execution instructions and result acquisition alone.

The computer program for the information processing device 100 may be provided pre-embedded in ROM or the like.

The computer program executed by the information processing device 100 has a module configuration that includes functions of the functional configuration described above that can also be implemented by the computer program. The above-described functional blocks are loaded, as actual hardware, onto the main storage 202 by the processor 201 that reads and executes the computer program from a storage medium. In other words, the above functional blocks are generated on the main storage 202.

Some of or all the functions described above may be implemented by hardware such as an integrated circuit (IC) instead of software.

A plurality of the processors 201 may be used for implementing the above-described functions. In the case, the processors 201 may implement one of the functions or two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising
a hardware processor connected to a memory and configured to:
calculate an error variation indicating a variation in error between a first absolute position of a mobile object and a relative position of the mobile object, the first absolute position being based on a global positioning system (GPS), the relative position being based on information other than the GPS;
calculate at least one section on a map in which the error variation is equal to or less than a first threshold value; and
calculate a second absolute position on the map such that a constant difference loss becomes smaller, the constant difference loss being used for causing a difference between the first absolute position and the second absolute position to be constant for each of the sections.

2. The information processing device according to claim 1, wherein the hardware processor is configured to calculate the second absolute position such that a correction position loss becomes smaller, the correction position loss being used for bringing the second absolute position at one or more time points closer to a correction position of the first absolute position obtained at the one or more time points.

3. The information processing device according to claim 2, wherein the hardware processor is configured to calculate the correction position by performing mapping between a landmark on a camera image taken by a camera of the mobile object and a landmark registered on the map, the mapping being performed based on an absolute position of the landmark registered on the map and the camera image.

4. The information processing device according to claim 2, wherein the hardware processor is configured to calculate the correction position from
map information in which road information is registered, the road information including at least one of a number of lanes, a lane centerline, or a road width,
a lane number identified from a camera image taken by a camera of the mobile object, and
a lane centerline of a road obtained by route matching of the first absolute position.

5. The information processing device according to claim 4, wherein the lane number identified from the camera image is identified by
an operational input from a user indicating a lane number,
image recognition processing to recognize a lane from the camera image, or
a deep neural network configured to answer a question about the camera image.

6. The information processing device according to claim 2, wherein the hardware processor is configured to:
compare a camera image taken by a camera of the mobile object with a mapping image correlated with an absolute position on the map; and
calculate the correction position based on the absolute position on the map correlated with the mapping image whose degree of similarity to the camera image is equal to or larger than a second threshold value.

7. The information processing device according to claim 2, wherein the hardware processor is configured to calculate the correction position based on a position acquired by using a beacon placed on a road or based on an operational input from a user indicating a position.

8. The information processing device according to claim 3, wherein the hardware processor is configured to adjust, to meet a method of calculating the correction position, a weight of the correction position loss for a traveling direction of the mobile object or a weight of the correction position loss for a left and right direction of the mobile object.

9. The information processing device according to claim 1, wherein
the hardware processor is configured to calculate the second absolute position such that a relative change loss becomes smaller, the relative change loss being used for bringing a time-series change in the second absolute position closer to a time-series change in the relative position, and
the second absolute position includes at least one of a position or an orientation of the mobile object.

10. The information processing device according to claim 9, wherein the hardware processor is configured to calculate the relative position based on at least one of a camera image taken by a camera of the mobile object, a wheel speed of the mobile object, a gyro sensor of the mobile object, or a light detection and ranging (LiDAR) sensor of the mobile object.

11. The information processing device according to claim 10, wherein
the hardware processor is configured to compare a trajectory of the relative position with a trajectory of the first absolute position, and
the error variation is at least one of
an error variation between a position of a trajectory of the relative position and a position of a trajectory of the first absolute position, or
an error variation between an orientation of the trajectory of the relative position and an orientation of the trajectory of the first absolute position.

12. The information processing device according to claim 10, wherein the hardware processor is configured to:
calculate an amount of change in at least one of a speed or an orientation of the mobile object based on the relative positions calculated at a plurality of time points, and
calculate a section in which the amount of change is equal to less than a third threshold value as the section on the map in which the error variation is equal to or less than the first threshold value.

13. The information processing device according to claim 10, wherein the hardware processor is configured to calculate a section in which accuracy of the GPS is equal to or larger than a fourth threshold value or a section in which a change in a number of positioning satellites of the GPS is equal to or less than a fifth threshold value, as the section on the map in which the error variation is equal to or less than the first threshold value.

14. The information processing device according to claim 1, wherein the first absolute position is an absolute position indicated by a value of the GPS or an absolute position obtained by correcting the value of the GPS by using road information including at least one of a number of lanes, a lane centerline, or a road width.

15. A computer program product comprising a non-transitory computer-readable recording medium on which a computer program executable by a computer is recorded, the computer program instructing the computer to perform processing, the processing including:
calculating an error variation indicating a variation in error between a first absolute position of a mobile object and a relative position of the mobile object, the first absolute position being based on a global positioning system (GPS), the relative position being based on information other than the GPS;
calculating at least one section on a map in which the error variation is equal to or less than a first threshold value; and
calculating a second absolute position on the map such that a constant difference loss becomes smaller, the constant difference loss being used for causing a difference between the first absolute position and the second absolute position to be constant for each of the sections.

16. An information processing method implemented by a computer, the method comprising:
calculating an error variation indicating a variation in error between a first absolute position of a mobile object and a relative position of the mobile object, the first absolute position being based on a global positioning system (GPS), the relative position being based on information other than the GPS;
calculating at least one section on a map in which the error variation is equal to or less than a first threshold value; and
calculating a second absolute position on the map such that a constant difference loss becomes smaller, the constant difference loss being used for causing a difference between the first absolute position and the second absolute position to be constant for each of the sections.
